(19) United States
(12) Patent Application Publication
(10) Pub. No.: US 2025/0335784 A1
(43) Pub. Date: Oct. 30, 2025

(54) PERSONALIZED FEDERATED LEARNING WITH VARIATIONAL INFERENCE

(71) Applicant: Google LLC, Mountain View, CA (US)

(72) Inventors: Elahe Vedadi, Mountain View, CA (US); Joshua Vincent Dillon, Mountain View, CA (US); Karan Singhal, Roslyn, NY (US); Philip Andrew Mansfield, Penticton (CA); Warren Richard Morningstar, Half Moon Bay, CA (US)

(21) Appl. No.: 18/651,025

(22) Filed: Apr. 30, 2024

(51) Int. Cl. G06N 3/098

(52) U.S. Cl. CPC G06N 3/098

(57) ABSTRACT

Methods, systems, and apparatus, including computer programs encoded on a computer storage medium, for receiving a user input from a user device, processing the user input using a shared embedding model to generate an embedded user input comprising global and local features, determining one or more parameters of an approximated global posterior distribution of local features by processing a first subset of global features using a shared constructor model, processing a second subset of global features using a shared global model to generate a global intermediate output, processing local data comprising the local features using a local model to generate a local intermediate output, wherein the local model comprises a set of local model parameters that have been sampled from a distribution characterized by the determined one or more parameters, and combining the global intermediate output and local intermediate output to generate a personalized output on the user device.

### BACKGROUND

This specification relates to processing data using machine learning models. Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

This specification is also directed to federated learning. Federated learning involves training one or more machine learning models on decentralized datasets in order to avoid aggregating data on a central server due to privacy concerns.

### SUMMARY

This specification describes a system implemented as computer programs on one or more user devices in one or more locations that can generate a personalized output on each user device without maintaining respective personalized models on each user device. In particular, the system can use a shared global model, e.g., a model with global parameters accessible by all user devices, to generate a respective first output that can be combined with a respective second output of a local model to personalize the output. In this specification, generating outputs from a local model on a user device without maintaining a local state including local model parameters or weights of each respective local model on each user device is referred to as stateless federated learning.

More specifically, the system can sample the parameters of each local model on each user device in response to a request for generating the personalized output each communication round, e.g., a training iteration in federated learning in which one or more shared models, e.g., shared models maintained on a central server accessible by all user devices, exchange updates with corresponding models on each user device. In particular, the system can use variational inference to approximate a global distribution of local parameters that a user device can sample from at each communication round to determine the local model parameters. In this specification, variational inference is a method for approximating a complex probability distribution by updating a simple parameterized distribution using data observations. In particular, the system can update the parameters of the simple distribution using an optimization to model the data received during training.

The system can maintain a shared global machine learning model (“global model”) on a central server and one or more local machine learning models (“local models”) that rely on sampling weights from an approximation of a global distribution of local parameters each communication round to generate the personalized output. In particular, the global and local models can be located on each user device and updated based on an aggregated update of the global model parameters on the central server. For example, the system can be used to provide a personalized output in an application being run on the user device, e.g., a messaging application, news source application, streaming service application, insurance application, e-commerce application, etc.

As an example, the system can be used to determine a personalized version of next-word or keyboard prediction when texting, writing an email, searching, etc. As another example, the system can be used to determine a personalized version of speech recognition when transcribing a text, dictating an email or a document, etc. As yet another example, the system can be used to tailor content presentation on a home screen of a news source, present personalized recommendation items on an e-commerce site, or present personalized movie recommendations.

According to a first aspect there is provided a method for receiving a user input from the user device, processing the user input using a shared embedding model to generate an embedded user input, wherein the embedded user input comprises global and local features, determining one or more parameters of an approximated global posterior distribution of local features by processing a first subset of global features using a shared constructor model, processing a second subset of global features using a shared global model to generate a global intermediate output, processing local data comprising the local features using a local model to generate a local intermediate output, wherein the local model comprises a set of local model parameters that have been sampled from a distribution characterized by the determined one or more parameters of the approximated global posterior distribution of local features, and combining the global intermediate output and local intermediate output to generate a personalized output on the user device.

Particular embodiments of the subject matter described in this specification can be implemented so as to realize one or more of the following advantages.

The system can allow for the prediction of personalized outputs on multiple user devices while respecting data privacy and without relying on maintaining a state for each user.

Many federated learning implementations include user devices that do not frequently participate in communication rounds, e.g., users that do not frequently use the application that includes the model that uses federated learning. In some cases, existing federated learning approaches rely on maintaining and using stale personalization models for generating an output for the infrequently participating users or maintaining and using a generic model for new or infrequent users. In contrast, generating a personalized output without the need to maintain a personalized model for each user device can decrease the computational overhead required, e.g., since no memory needs to be allocated for storing the stale personalized model between communication rounds, and increase the accuracy of the personalized output for users that do not participate often in communication rounds. For example, rather than maintaining a potentially stale or non-existing state for non-participating users, the system can sample the parameters from the most recently approximated global posterior distribution of location features at each communication round.

Additionally, the system can use variational inference to approximate the distribution of local features, e.g., rather than relying on a point estimate of model weights for the local model. In particular, the system can train the model on a loss function that penalizes the difference between a surrogate distribution and the approximated global distribution of local parameters in order to enhance the ability of the model to replicate personalized outputs with high-fidelity. Using variational inference can allow the system to explicitly account for the uncertainty in the data being used to train the model, e.g., the uncertainty as a result of local data indirectly incorporated from participating user devices, and thereby enable the generation of a more robust personalized output for each participating user device.

The system can also reduce the use of computational resources by maintaining modular embedding, local, global, and constructor models. In particular, maintaining an embedding model to process local data and generate an embedded user input that can be divided into global and local features allows the implementation of smaller global and local models, e.g., distinct models with simpler architectures and less parameters. Moreover, the modular local and global models reduce the total transmission of parameters between each user device and the central server at each communication round, e.g., since the system only needs to transmit one of the global parameters to the central server, relative to standard personalized federated learning techniques, e.g., client-side model personalization, personalized tuning of the global model using transfer learning, meta-learning, etc., which rely on aggregating the changes of all model parameters on the central server.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram that provides an overview of generating a personalized output for a user device.

FIG. 2 is a system diagram of an example variational inference federated learning system.

FIG. 3 depicts example results that demonstrate how incorporating variational inference improves personalization output accuracy with respect to point estimate prediction.

FIG. 4 is a flow diagram of an example process for generating a personalized output on a user device.

FIG. 5 is a flow diagram of an example process for training a variational inference federated learning system.

Like reference numbers and designations in the various drawings indicate like elements.

### DETAILED DESCRIPTION

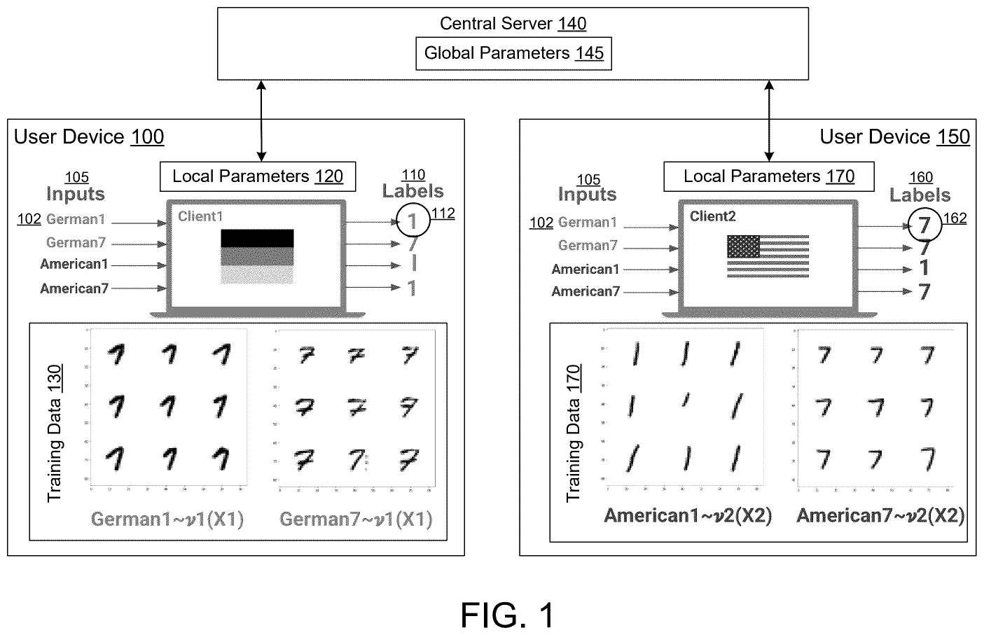

FIG. 1 is a block diagram that provides an overview of generating a personalized output for a user device using stateless variational federated learning to provide a personalization output on participating user devices.

The example of FIG. 1 is a stateless federated learning setup as part of a stateless variational federated learning system with multiple users and a central server, e.g., where a subset of user devices participate in each communication round. In this context, a communication round is a training iteration in which one or more shared models exchange updates with corresponding models on each user device.

The participating user devices for the current communication round, e.g., the communication round depicted in FIG. 1, are user device 100 and user device 150. In this case, the setup is stateless, e.g., the system can generate personalized outputs from a local model on a user device without maintaining model parameters of each respective local model on the user device 100, 150 or any user data, e.g., the training data 130 or 160. In particular, the data 130 and 160 remains on-device for every communication round.

In this case, the system can use variational inference as part of the stateless federated learning setup, e.g., to approximate a global distribution of local parameters that a user device can sample from at each communication round to determine the local model parameters, as will be described in further detail below.

In this setup, the model parameters parameterizing each user model can be categorized as global parameters and local parameters, e.g., belonging to a local model and a shared global model. In some cases, the global and local parameters can belong to different subsets of the same model, e.g., the global or local model can be partitioned among multiple models. In particular, the global parameters 145 can be shared by all user devices throughout the course of federated learning and can be maintained, e.g., updated, at the central server 140 after each communication round, while the local parameters 120, 170 can be sampled each communication round on the respective user devices to maintain privacy.

In this case, the user device 100 is located in a German-speaking country and the user device 150 is located in an English-speaking country. Each user model processes inputs 105 that include handwritten numbers and letters from the respective user devices 100, 150 to generate a predicted label output for each letter or number as a personalization output, e.g., the personalization outputs 110 and 160, respectively.

More specifically, each user device 100, 150 can maintain a respective local model parameterized by the respective local parameters 120, 170 that can generate personalized outputs, e.g., the personalization outputs 110 and 160, for each user device. In the particular example depicted, the system cannot rely on a shared model alone to generate the personalization outputs 110 and 160 since that would not account for the differences between the data 130 and 170, which can conflict.

For example, the user of user device 100 in the German-speaking country may include a horizontal middle bar when writing sevens, whereas the user of the user device 150 in the English-speaking country may not. Likewise, the user of user device 100 may add a hood to the number one, while the user of user device 150 may not. These differences indicate that the different predictive distributions of users participating in a communication round can conflict, e.g., the user of user device 100 may see the user of user device 150 1 as a 7, while the user of user device 100 may see the user of user device 150's 7 as a lowercase “1” since user device 100 is located in a German-speaking country and user device 150 is located in an English-speaking country.

Since each user device's input data reflects the unique writing style of the user, the system can incorporate some level of local adjustments, e.g., using a local model parameterized by the local parameters 120 and 170, in order to generate accurate personalized outputs. In the particular example depicted, the model for user device 100 generates a different output than the model for user device 150, e.g., the German1 102 of the inputs 105 to each respective model returns a 1 112 in the case of the user device 100 located in a German-speaking country and a 7 162 in the case of the user device 150 located in the English-speaking country.

The stateless federated learning setup as depicted with each user device, e.g., the devices 100 and 150, having a respective model that includes global and local parameters can be framed as a hierarchical data generation process, e.g., where each user has a different underlying data distribution. In the particular example depicted, the difference between the German 1102 being viewed as a 1 in some cases and as a 7 in others demonstrates how data may not exhibit identical and independently distributed characteristics among user devices.

More specifically, the global parameters 0 145 can be understood as a set of parameters drawn from a global prior distribution, e.g., θ˜t(θ), and each respective set of local parameters βᵤ for each user u, e.g., the set of local parameters 120 and 170, for each user device, e.g., the user device 100 and 150, can be understood as a set drawn from a local prior distribution βᵤ˜r(Bᵤ), and the underlying data distribution for each user u, can be understood as xᵢᵤ˜vᵤ(X). Therefore, the predicted personalization output for each user can be understood as a deterministic likelihood L of a personalized output given a function of data samples, and global and local parameters: yᵢᵤ˜L(Y|f(θ, βᵤ, xᵢᵤ)). Although all users share the same likelihood distribution family yᵢᵤ, the distribution can vary based on the user u, e.g., the personalized outputs can differ based on each user.

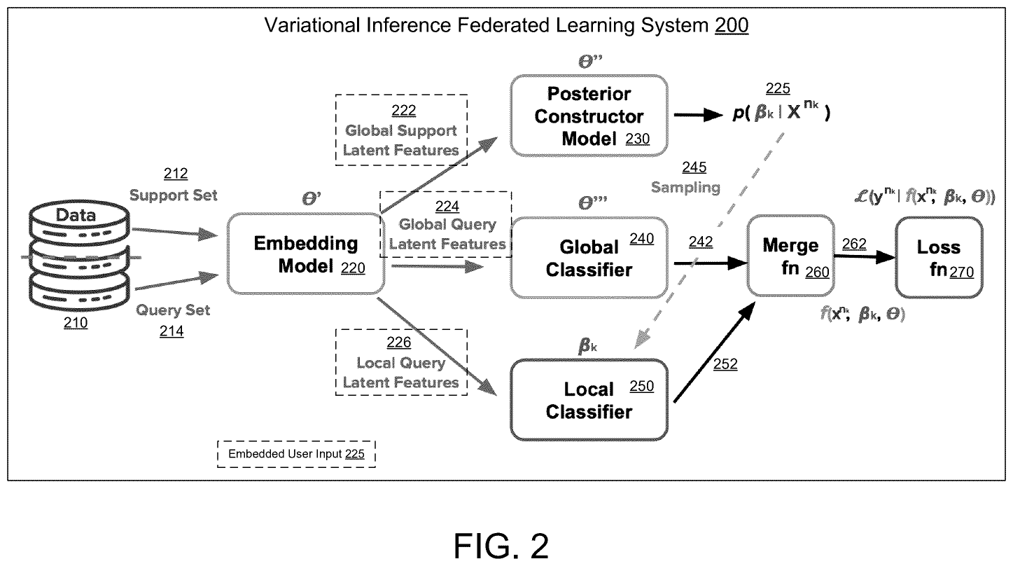

FIG. 2 shows an example variational inference federated learning system 200. The variational inference federated learning system 200 is an example of a system implemented as computer programs on a user-device in which the systems, components, and techniques described below are implemented.

More specifically, the variational inference federated learning system 200 can be used to implement the stateless variational federated learning technique described in FIG. 1, e.g., to generate an accurate personalization output while protecting data privacy. In the particular example depicted, the personalization output is a classification class, but the system described can be adapted for a variety of federated learning tasks.

The system 200 can partition each user model as a shared embedding model 220, shared posterior constructor model 230, shared global model, e.g., a shared global classifier 240, and a local model, e.g., a local classifier 250. In this case, the global model includes the shared embedding model 220, the shared posterior constructor model 230, and the shared global classifier 240, e.g., the respective sets of parameters of the models 220, 230, and 240 are the global parameters, e.g., parameters that are shared among multiple user devices. As an example, the global parameters can be maintained on a central server, e.g., updates to the global parameters can be aggregated at the central server and transmitted back to each user device.

The shared embedding model 220, shared posterior constructor model 230, shared global classifier 240, and the local classifier 250 can be parameterized to correspond with the likelihood L of a personalized output given a function of data samples, and global and local parameters: yᵢᵤ˜L(Y|f(θ, βᵤ, xᵢᵤ)). In particular, the shared global classifier 240 can have a set of shared parameters drawn from a global prior distribution, e.g., θ˜t(θ), and the local model 250 can have a set of parameters drawn from a local prior distribution, e.g., βᵤ˜r(βᵤ). In this case, the local prior distribution is modeled as the global posterior of local parameters, e.g., as approximated by the posterior constructor model 230 using global features, as will be described in more detail below.

In this case, the process of variational federated learning that the system implements can be written as the joint probability distribution t(Θ) ↑9_{u∈c} r(βᵤ) Π_{u∈c} Π_{i∈n} L(yᵢᵤ|f(θ, βᵤ, xᵢᵤ)), where c is the set of all possible users and n is the number of participating users, which can be simplified as a product of the prior distribution of global parameters, prior distribution of local parameters, and likelihood of the personalized output given a function of data samples, local, and global parameters: t(Θ) r(B_{c})L(Y|f(θ, B_{c}, X). The likelihood can be optimized by updating the parameters of the models with respect to a loss function, as will be described in more detail below.

The variational inference federated learning system 200 can receive a user input, e.g., data 210, from a user device. In particular, the system 200 can determine a subset of participating user devices for each communication round, e.g., the subset u from the possible users c, e.g., based on which user devices are actively using the federated learning model at the time the system starts the communication round. In some cases, a user device might not be using the model, e.g., the user device can be using one or more different software applications than the software application that includes the model being trained with the system 200. As an example, the subset u can be a randomly sampled subset of the possible users c.

As an example, the data 210 can be text or email message data. As another example, the data 210 can be search history data, streaming service recommendation data, or e-commerce purchase data. As yet another example, the data 210 can be data pertaining to insurance or financial transactions. As a further example the data 210 can be image, audio, or video data.

In some cases, the user input can include data that does not pertain directly to generating the personalization output. In particular, the system 200 can process data 210 that provides auxiliary information, e.g., data that might correlate with the personalization output or prove useful in some other way. For example, in the case of classifying hand-written digits, the data 210 can also include information on pressure sensitivity, whether the user is right-handed, left-handed, or ambidextrous, whether the user has experienced a wrist or hand injury, etc.

In the particular example depicted, the data 210 can be divided into a support set 212 and a query set 214. For example, the support set 212 can be used to approximate the global posterior distribution of local features, e.g., in order to sample the local parameters of the local classifier 250, and the query set 214 can be used to make predictions, e.g., to generate the personalized output with both the global classifier 240 and the local classifier 250. In some cases, the support set 212 and the query set 214 are not required to be disjoint.

The system 200 can process the data 210, e.g., the support set 212 and the query set 214, using an embedding model 220 to generate an embedded user input 225, e.g., the latent features 222, 224, and 226. The embedding model 220 can be a neural network with any appropriate machine learning architecture that can be configured to process the data 210 to generate a representation of the data in a latent embedding space, e.g., a multi-dimensional space of a different size or shape than the size or shape of the input space of the data 210. For example, the embedding model 220 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers). In particular, the final layer of the embedding model 220 can generate a representation of the data in the latent embedding space.

As an example, the embedding model 220 can be a feed-forward neural network, e.g., a multi-layer perceptron (MLP), that includes multiple fully-connected layers. As another example, the embedding model 220 can be a convolutional neural network (CNN), e.g., a neural network having a ResNet architecture, an Inception architecture, an EfficientNet architecture, etc. As yet another example, when the inputs are text, audio data, or other sequential data, the embedding model 220 can be a recurrent neural network, e.g., a long short-term memory (LSTM) or gated recurrent unit (GRU) based neural network, or a large language model, e.g., a Transformer neural network.

In particular, the embedding model 220 can be an encoder model. The encoder model can be used to generate an embedded user input 225 in a lower-dimensional space than the space of the input data 210, e.g., the embedding model 220 can extract relevant features from the input data into a more compact representation. In this case, the embedding model 220 can be a feedforward encoder, a convolutional encoder, a recurrent encoder, a variational autoencoder, etc. For example, the embedding model 220 can be a convolutional encoder with two to five embedding layers.

The embedded user input 225 can then be divided into global and local features, e.g., the global support 222 and query 224 latent features and the local query latent features 226. In the particular example depicted, the system can further separate the global and local features into corresponding support and query set, e.g., based on which parts of the embedded user input 225, are from the support set 212 or query set 214 at the outset of training. In particular, the system can process the embedded user input 225 and determine whether the features are global features, e.g., general shared features, or local features, e.g., personalization features.

The partition between the global and local features, e.g., which parts of the embedding vector are global features and which parts of the embedding vector are local features, can be learned during the model training process. In particular, the embedding model 220 can learn to map the global features together in a region of the embedding space and the local features together in a separate region. The vector representation of the embedded user input can be partitioned into two subsets, e.g., using a data split function, e.g., to select the first X amount of features as the global features and the remaining features as local features. As another example, the system 200 can determine the partition between the global and local features using a set proportioning value of the embedded user input 225, e.g., 80% of the vector representation of the embedded user input 225 can be designated as global features and the remaining 20% of the vector representation of the embedded user input 225 can be local features.

In this case, the system can process the global support latent features 222 using the shared posterior constructor model 230 to approximate the global posterior distribution of local features, e.g., p(βᵤ|xᵢᵤ) 225. The shared posterior constructor model 230 can be a neural network with any appropriate machine learning architecture that can be configured to process embedded global features, e.g., the global support latent features 222, to generate one or more parameters of the approximated global posterior distribution of local features. In particular, the system can generate one or more summary statistics of the approximated global posterior distribution of local features, e.g., a mean, variance, and bias estimate of the posterior.

For example, the embedding model 220 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

More specifically, the shared posterior constructor model 230 can be implemented with an architecture that incorporates probabilistic techniques to account for the uncertainty in approximating the global posterior distribution of global features 225. As an example, the shared posterior constructor model 230 can be an encoder-decoder network, e.g., a variational autoencoder, a normalizing flow, or a Bayesian network, e.g., a Bayesian neural network or a Bayesian recurrent neural network.

In particular, the system can approximate the global posterior distribution of local features 225 using variational inference. More specifically, the system can process the global support latent features 222 and one or more surrogate distribution types, e.g., a guess of a type of distribution that can be determined to be relevant to modeling the posterior. As an example, the surrogate distributions can be determined from the user inputs, e.g., the system can receive a distribution type for variational inference or can analyze the input data 210 in order to determine a guess for the type of underlying global posterior distribution of local features. In this case, the type of distribution can refer to a Gaussian, narrow normal, binomial, Beta, multi-modal, etc. distribution. Each of the one or more surrogate distributions can be parameterized by a set of variational parameters that can be updated through an optimization, e.g., gradient descent or stochastic gradient descent, e.g., to reflect updated beliefs after observing the data during training.

The system can use the approximated global posterior distribution of features 225 to sample the parameters of the local classifier 250 on each respective user device, e.g., using any appropriate sampling technique. In particular, at the beginning of each communication round, the system 200 can use the generated one or more parameters of the approximated posterior 225 to sample 245 the parameters of the local classifier 250, e.g., from a distribution that is parameterized by one or more predicted summary statistics, e.g., the predicted mean, variance, and bias estimate of the posterior. In this case, sampling 245 refers to determining the values of the local model parameters from a distribution characterized by the determined summary statistics, e.g., the determined mean, variance, and bias values.

More specifically, the system 200 can sample the parameter values at the start of each communication round to ensure accurate personalization output predictions for local models, especially on user devices that do not often participate in communication rounds. Instead of maintaining a state for each user device, e.g., a state that can quickly become stale or can even be non-existent, the system 200 can sample 245 the local parameter values each round from the most recently updated approximation of the global distribution of local parameters 225.

The system 200 can process the global query latent features 224 using the global classifier 240 to generate a global intermediate output 242 and the local query latent features 226 using the local classifier 250 to generate a local intermediate output 252. In this case, the global classifier 240 and the local classifier 250 can be configured to output intermediate classification outputs of the same size, e.g., an embedding with dimension size corresponding with the number of classes being considered in the handwritten digit classification context. While the particular example depicted is for a classification personalization output, the system 200 can process the global query latent features 224 with a global model or local model configured for any machine learning task to generate the global intermediate and local intermediate outputs, respectively.

Likewise, each of the global classifier 240 and the local classifier 250 can be a neural network with any appropriate machine learning architecture that can be configured to process the global 224 or local 226 query latent features 224 to generate a global 242 or local 252 intermediate output, respectively. In particular, the embedding model 220 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers). In some cases, the global classifier 240 and local classifier 250 can be implemented using the same model architecture. In other cases, the global classifier 240 and local classifier 250 can be implemented using different model architectures.

In particular, the global 240 and local 250 classifiers can be implemented as smaller models, e.g., models with fewer parameters than the embedding model 220, e.g., since they receive the embedded input data instead of receiving the input data and having to process the input data to generate a latent representation. For example, in the particular example depicted the global 240 and local 250 classifiers can be implemented as one dense layer with the output size corresponding with the number of classes for classification and no activation function. More specifically, the system can combine the embedding model 220 and the global classifier 240 model or the embedding model 230 and the local classifier model 250 to accomplish generating the same intermediate outputs 242 and 252, but at a much higher computational cost.

The system 200 can then combine the global intermediate output 242 and the local intermediate output 252, e.g., using a merge function 260, to generate a corrected intermediate output 262, e.g., a corrected intermediate output that modifies the generic global output 242 as specified by the local intermediate output 252. The system 200 can then apply an activation function to the corrected intermediate output 262 to generate the personalized output.

As an example, the system 200 can directly add or compute a mean, e.g., a weighted average, of the corresponding values of the global intermediate output 242 and the local intermediate output 252 as the merge function 260 to generate the corrected intermediate output 262. In the case that the system 200 computes a weighted average, the system 200 can use the division between the global and local features in the embedded input to determine the weights. As another example, the system 200 can perform element-wise multiplication or a weighted sum to combine the global intermediate output 242 and the local intermediate output 252 as the merge function 260 to generate the corrected intermediate output 262.

In the particular example depicted, the personalized output is indicative of a class in a predicted classification. In this case, the activation function can comprise a function to convert intermediate output logits into probabilities of each class, e.g., a softmax function, sigmoid function, tanh function, etc. In the case in which the personalized output is a value of a predicted regression, the activation function can comprise a full or partly linear function or a linear approximation, e.g., ReLU, Leaky ReLU, softplus function, etc.

In another example, the personalized output is an autoregressively generated sequence of predicted next elements, e.g., the output of an RNN, LSTM, or decoder-based model, e.g., Transformer. In this case, the system can combine the intermediate generated embeddings of the global intermediate output 242 and the local intermediate output 252, respectively, e.g., by taking a mean, concatenating the embeddings, or taking a vote on the next element output. As yet another example, the system 200 can use a dynamic attention mechanism to weight the output probabilities of the global intermediate output 242 and the local intermediate output 252. In the case in which the personalized output is an autoregressively generated sequence of predicted next elements, the system can decode the combined embeddings, e.g., using respective tokenizer for each output modality, to generate the personalized output.

The system 200 can provide the personalization output as output on the user device and can receive or determine a corresponding ground truth output after the system makes the prediction. In particular, the system can receive the ground truth output from the data 210, e.g., the ground truth output can be a part of a labeled data set, e.g., a labeled query set. In other cases, the system 200 can implement a feedback mechanism using user-provided feedback, e.g., immediately user-rejected or accepted personalized output predictions or previously rejected or accepted output predictions on the user device, to infer the ground truth for previously predicted personalization outputs. The system 200 can then use the personalization output to determine a loss function 270, e.g., by comparing the personalization output to the ground truth output, e.g., from the labeled query set.

In the particular example depicted, the system 200 can use the correct class label for the classification task to determine a classification loss. As an example, the system 200 can compute the log-likelihood between the personalization output and the ground truth output as the discrepancy or can use a cross-entropy loss, e.g., a binary cross entropy or categorical cross-entropy loss, or a hinge loss to determine the discrepancy. As another example, the system can determine a regression loss, e.g., a loss for a regression task, e.g., by computing a L1 or L2 loss, mean absolute error, Huber loss, Hinge loss, etc.

The loss function 270 can include multiple losses, e.g., the classification loss described above and a loss determined based on a divergence. In particular, the system can approximate the global distribution of local parameters by minimizing the evidence lower bound (ELBO) of the data with respect to the variational parameters, which is equivalent to minimizing the Kullback-Leibler (KL) divergence between the approximated global posterior distribution of local features and the surrogate distributions as determined after observing the data.

Using the ELBO loss function provides a generalization guarantee for the stateless federated variational learning technique disclosed herein, e.g., by providing a guarantee that minimizing the objective function is equivalent to minimizing an upper bound on the generalization error. In particular, using variational inference to learn the distribution of the global parameters instead of learning point estimates provides a formal generalization guarantee on unseen user device data.

The system 200 can then generate the corresponding personalization outputs on each user device, e.g., using the shared embedding model 220, the shared posterior constructor model 230, the shared global classifier 240, and each respective local classifier on each participating user device, and calculate the loss function 270. The loss function 270 can be used to train the shared models, e.g., the shared embedding model 220, the shared posterior constructor model 230, and the shared global classifier 240, at each of a number of training iterations, e.g., communication rounds.

More specifically, the shared models 220, 230, and 240 can be trained by calculating and backpropagating gradients of the loss function 270 to update the respective values of the parameters of each model, e.g., using the update rule of any appropriate gradient descent optimization algorithm, e.g., RMSprop or Adam. As mentioned previously, the parameters of each local model can be determined by sampling from the approximated global posterior distribution of local parameters at each communication round, e.g., the local parameters are dependent on the updated parameters of the constructor model.

The shared global parameters, e.g., the respective parameters of the shared embedding model 220, the shared posterior constructor model 230, and the shared global classifier 240, can be updated through backpropagation using the loss function 270 on each respective user device. The system 200 can then send the local update, e.g., from each user device, of the global parameters along with the number of query data samples for the user of each user device to the central server for aggregation, e.g., the server can separately aggregate all user updates for each shared model 220, 230, and 240 to calculate the global update of the global parameters. The system can then transmit the updated global parameters from the central server to the clients for the next iteration of training, e.g., the next communication round.

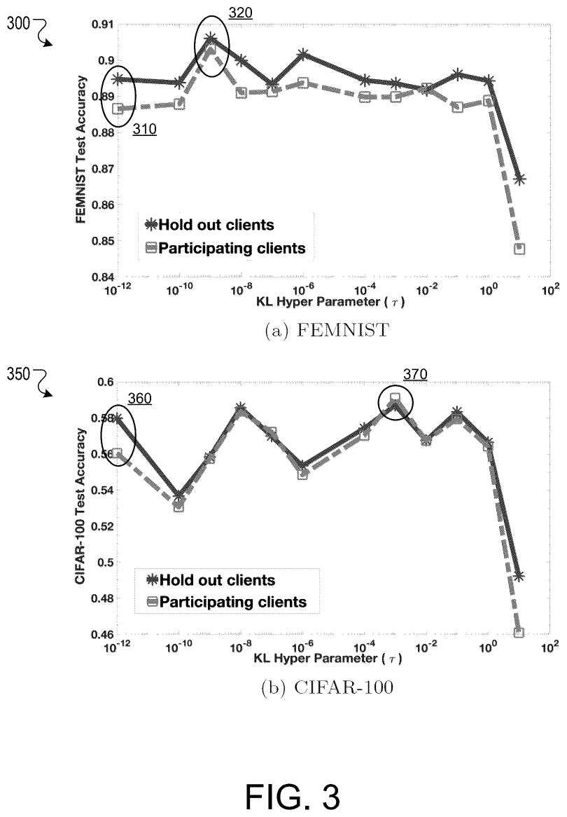

FIG. 3 demonstrates how incorporating variational inference improves personalization output accuracy with respect to point estimate prediction, e.g., by training a model using the variational federated learning system of FIG. 2.

In particular, FIG. 3 includes two graphs, e.g., graph 300 and graph 340, that show the dependence of personalization output accuracy for both participating user devices, e.g., participating clients, and non-participating user devices, e.g., hold out clients, based on a KL hyperparameter τ that controls the weight of the KL divergence in the loss function, e.g., the closer τ is to 0, the less the loss depends on approximating the global posterior distribution of local parameters and the more the loss penalizes similar to a point estimate penalty.

In this case, participating users are users that were seen during training, e.g., users that participated in at least one communication round, and non-participating users are users that did not participate in any communication rounds. The generalization gap refers to the difference between the participating and non-participating user accuracy, e.g., the smaller the gap between the participating and non-participating users, the more the model is able to generalize to unseen users with high fidelity.

Graph 300 shows the average test accuracy of the last 100 rounds of training for a model trained using the Federated Extended MNIST dataset (FEMNIST) for a range of KL hyperparameter values of τ. The horizontal axis of graph 350 is semi-logarithmic, e.g., the test accuracy results of τ=0 are shown at point τ=10⁻¹². In this case, τ=10⁻⁹ outperforms other values, achieving higher accuracy with a smaller generalization gap 320 compared to the generalization gap 310 at τ=0.

Graph 350 shows the average test accuracy of the last 100 rounds of training for a model trained using the CIFAR-100 dataset for a range of KL hyperparameter values of τ. Likewise, the horizontal axis of graph 350 is semi-logarithmic, e.g., the test accuracy results of τ=0 are shown at point τ=10⁻¹². In this case, τ=10⁻³ achieves the highest accuracy for both participating and nonparticipating users with a low generalization gap 370. Comparing to the generalization gap 360 at τ=0 to larger values of t reveals that minimizing the KL divergence, e.g., with τ>0, as opposed to the point estimate, reduces the gap in participation test accuracy.

While minimizing the KL divergence does not demonstrate a direct trend in reducing the generalization gap in graph 300, comparing graph 300 to graph 350 demonstrates that the difference in test accuracy between τ=0 and τ=10⁻⁹ in graph 300 is significantly larger than the difference between τ=0 and τ=10⁻⁹ in the graph 350 experiment, which suggests that minimizing KL divergence is more critical for the FEMNIST dataset than for CIFAR-100 dataset. One possible explanation is that in the FEMNIST dataset, each client's underlying data distribution naturally differs, while in the CIFAR-100 dataset, data is synthetically partitioned and distributed among clients.

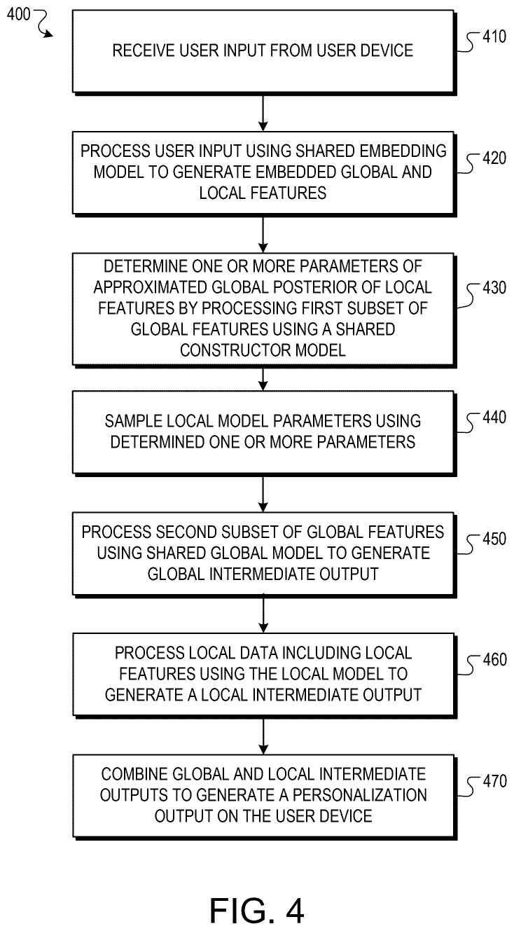

FIG. 4 is a flow diagram of an example process for generating a personalized output on a user device. For convenience, the process 400 will be described as being performed by a system operating on one or more user devices in one or more locations. For example, a variational inference federated learning system, e.g., the variational inference federated learning system 200 of FIG. 2, appropriately programmed in accordance with this specification, can perform the process 400.

The system can receive a user input from a user device (step 410). In particular, the system can receive data from a user device, e.g., data that either pertains directly to generating the personalization output or data that provides auxiliary information. As an example, the data can be textual or numerical data, e.g., text or email message data, e-commerce search history data, movie recommendation data, etc. As another example, the data can be image, audio, or video data. In some cases, the input data can be divided into a support set, e.g., an unlabeled set, and a query set, e.g., a labeled set.

The system can process the user input using a shared embedding model to generate embedded global and local features (step 420). More specifically, the system can process the user input using an embedding model with shared parameters, e.g., global parameters that are shared amongst one or more user devices, in order to generate an embedded user input. The embedded user input can then be partitioned into global and local features, e.g., 80% of features can be designated as global features and 20% of features can be designated as local features. As another example, the first N features can be designated as global features and the remaining subset can be designated as local features. As yet another example, the partition between global and local features can be learned, e.g., which subset of the embedded user input are global features and which subset of the embedded user input are local features. Furthermore, in the case that the input data can be divided into a support set and a query set, the system can further separate the global and local features into corresponding support and query set, e.g., based on which parts of the embedded user input are from the support set or query set at the outset of training.

The system can determine one or more parameters of an approximated global posterior of local features using a shared constructor model (step 430). In particular, the system can process a first subset of embedded global features from step 420 using the shared constructor model to generate one or more summary statistics of the distribution, e.g., a mean, variance, and bias of the global posterior of local features. For example, in the case that the input data includes a support set and a query set and the global features are further divided into global query and support features, the system can process the global support features to generate the one or more parameters of the approximated global posterior of local features.

The system can use the constructor model approximation of the global posterior distribution of local features to sample local model parameters (step 440). In this case, the system can sample the local model parameters from a distribution parameterized by the determined one or more parameters, e.g., the determined mean, variance, and bias, of the global posterior distribution of local features. In particular, the system can sample the local model parameters at each communication round, e.g., such that the system does not need to rely on maintaining a stale model for each user device.

The system can then process a second subset of the global features using a shared global model to generate a global intermediate output (step 450) and the local features using a local model to generate a local intermediate output (step 460). In the case that the input data includes a support set and a query set and the global and local features are further divided into global query and support features, respectively, the system can process the global support features using the shared global model to generate the global intermediate output. In this case, the system can process the local query latent features using the local model to generate the local intermediate output.

In an example of a classification task, the shared global model and the local model can be configured to output intermediate classification outputs of the same size, e.g., an embedding with dimension size corresponding with the number of classes being considered. In an example of a regression task, the shared global model can output an embedding corresponding with an intermediate value and the local model can output an embedding corresponding with an intermediate correction value. In an example of an autoregressive generation of a sequence of next elements task, the shared global model can output a sequence of embeddings corresponding with an intermediate sequence of embeddings and the local model can output a sequence of embeddings corresponding with an intermediate sequence of correction values for each embedding.

The system can then combine global and local intermediate outputs to generate a personalization output on the user device (step 470). In particular, the system can combine the global intermediate output and the local intermediate output to generate a corrected intermediate output. As an example, the system can directly add the global intermediate output and the local intermediate output or compute a weighted sum of the values in the global and local intermediate outputs. As another example, the system can perform element-wise multiplication. As yet another example, the system can use a dynamic attention mechanism to weight the output probabilities of the global intermediate output and the local intermediate output. In some cases, the system can then apply an activation function to the corrected intermediate output to generate the personalized output. In other cases, the system can decode combined embeddings, e.g., using respective tokenizers for each output modality, to generate the personalized output.

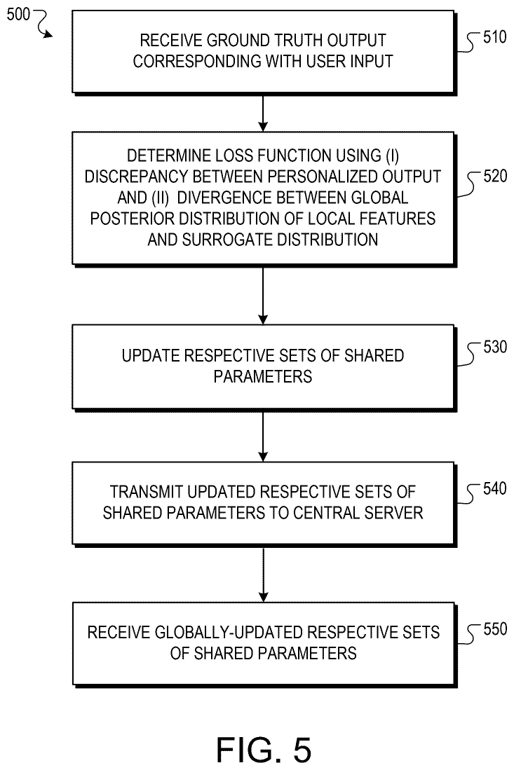

FIG. 5 is a flow diagram of an example process 500 for training a model using a variational inference federated learning system. For convenience, the process 500 will be described as being performed by a system operating on one or more user devices located in one or more locations. For example, a variational inference federated learning system, e.g., the variational inference federated learning system 200 of FIG. 2, appropriately programmed in accordance with this specification, can perform the process 500.

The system can receive a ground truth output corresponding with the user input (step 510), e.g., the ground truth output can provide a baseline output to compare the personalization output against. As an example, the system can receive the ground truth output from the user, e.g., as part of input data. In other cases, the system can implement a feedback mechanism using user-provided feedback, e.g., immediately user-rejected or accepted personalized output predictions or previously rejected or accepted output predictions on the user device, to infer the ground truth for previously predicted personalization outputs.

The system can then determine a loss function based on a discrepancy between the personalized output, e.g., a log-likelihood or cross-entropy loss for a classification task or an L1 or L2 loss for a regression task, and a divergence between the global posterior distribution of local features and a surrogate distribution (step 520). In particular, the system can approximate the surrogate distribution using variational inference. In this case, the system can minimize the evidence lower bound (ELBO) of the data with respect to the variational parameters in the shared constructor model, which is equivalent to minimizing the Kullback-Leibler (KL) divergence between an underlying global posterior distribution of local features and the surrogate distribution as determined after observing the data.

The system can then update the respective sets of shared parameters of the global models on the user device in accordance with minimizing the loss function (step 530), e.g., the system can update the respective sets of parameters of the shared embedding model, the shared constructor model, and the shared global model. As an example, the respective sets of shared parameters can be updated on the user device through backpropagation using the loss function determined in step 550. In particular, the system can backpropagate gradients of the loss function to update the respective sets of shared parameters of each model, e.g., using the update rule of any appropriate gradient descent optimization algorithm, e.g., RMSprop or Adam.

The system can then transmit the respective sets of shared parameters to the central server (step 540). In some cases, the system can additionally transmit a corresponding number of samples in the user input for the training iteration. The system can then receive globally-updated respective sets of shared parameters, e.g., respective sets of shared parameters that have been aggregated on the central server, e.g., based on the relative corresponding number of samples for the subset of participating user devices.

The system can receive globally-updated respective sets of shared parameters (step 550), e.g., the globally-updated respective sets of shared parameters that have been aggregated on the central server. In particular, the system can update the shared embedding model, the shared constructor model, and the shared global model using the received globally-updated respective sets of shared parameters. The system can then sample the set of local model parameters using the updated shared constructor model.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.c., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.c., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order. to achieve desirable results. In some cases, multitasking and parallel processing may be advantageous.

1. A computer-implemented method for generating a personalized output on a user device, the method comprising:
receiving a user input from the user device;
processing the user input using a shared embedding model to generate an embedded user input, wherein the embedded user input comprises global and local features;
determining one or more parameters of an approximated global posterior distribution of local features by processing a first subset of global features using a shared constructor model;
processing a second subset of global features using a shared global model to generate a global intermediate output;
processing local data comprising the local features using a local model to generate a local intermediate output, wherein the local model comprises a set of local model parameters that have been sampled from a distribution characterized by the determined one or more parameters of the approximated global posterior distribution of local features; and
combining the global intermediate output and local intermediate output to generate a personalized output on the user device.

2. The method of claim 1, wherein the user input comprises a support set and a query set, wherein the first subset of the global features are embeddings of the support set, wherein the second subset of the global features are embeddings of the query set, and wherein the local features are embeddings of the query set.

3. The method of claim 2, wherein the personalized output is a prediction for the query set.

4. The method of claim 1, wherein the shared embedding model comprises a set of shared embedding parameters and is accessible by a plurality of user devices on a central server, and wherein the shared global model comprises a set of shared global parameters and is accessible by the plurality of user devices on the central server.

5. The method of claim 1, wherein the local intermediate output comprises a local correction output, and wherein combining the respective pair of global and local intermediate outputs to generate a personalized output on the user device comprises:
adding the global intermediate output and the local correction output to generate a corrected intermediate output; and
processing the corrected intermediate output to generate the personalized output.

6. The method of claim 5, wherein processing the corrected intermediate output to generate the personalized output comprises applying an activation function to the corrected intermediate output.

7. The method of claim 6, wherein the personalized output is indicative of a class in a predicted classification, and wherein the activation function comprises a softmax function.

8. The method of claim 6, wherein the personalized output is a value of a predicted regression, and wherein the activation function comprises a linear function.

9. The method of claim 5, wherein adding the global intermediate output and the local correction output to generate a corrected intermediate output comprises adding a global intermediate sequence of embeddings and a local intermediate sequence of embeddings to generate a corrected intermediate output sequence of embeddings, and wherein processing the corrected intermediate output sequence of embeddings to generate the personalized output comprises:
decoding the corrected intermediate output sequence of embeddings to generate the personalized output.

10. The method of claim 1, wherein determining the one or more parameters of the approximated global posterior distribution of local features by processing the first subset of global features using a shared constructor model further comprises:
determining one or more of mean, variance, or bias parameters of the approximated global posterior distribution of local features.

11. The method of claim 1, further comprising, at each of a number of training iterations:
receiving a ground truth output corresponding with the user input;
determining a loss function based on a discrepancy between the corresponding personalized output and the ground truth output and a divergence between an underlying global posterior distribution of local features and a surrogate posterior distribution, wherein the surrogate posterior distribution has been approximated using variational inference;
updating respective sets of shared parameters comprising respective sets of parameters of the shared embedding model, the shared constructor model, and the shared global model on each user device in accordance with minimizing the loss function; and
transmitting the updated respective sets of shared parameters to the central server with a corresponding number of samples in the user input for the training iteration.

12. The method of claim 11, further comprising, at each training iteration:
receiving globally-updated respective sets of shared parameters that have been aggregated on the central server;
updating the shared embedding model, the shared constructor model, and the shared global model using the globally-updated respective sets of shared parameters; and
sampling the set of local model parameters from the distribution characterized by the determined one or more parameters of the approximated global posterior distribution of local features using the shared constructor model that has been updated with the globally-updated respective sets of shared model parameters.

13. The method of claim 12, wherein the globally-updated respective sets of shared parameters comprises an aggregation of the respective sets of shared parameters from a plurality of user devices, and wherein the aggregation comprises an aggregation using respective weights based at least on the corresponding number of samples for each user device.

14. The method of claim 11, wherein the divergence comprises a Kullback-Leibler divergence.

15. The method of claim 11, wherein updating the set of parameters of the shared constructor model on each user device in accordance with minimizing the loss function, further comprises:
receiving a selection of a distribution type to model the surrogate posterior in a first training iteration.

16. A system comprising one or more computers and one or more storage devices storing instructions that are operable, when executed by the one or more computers, to cause the one or more computers to perform a method comprising:
receiving a user input from the user device;
processing the user input using a shared embedding model to generate an embedded user input, wherein the embedded user input comprises global and local features;
determining one or more parameters of an approximated global posterior distribution of local features by processing a first subset of global features using a shared constructor model;
processing a second subset of global features using a shared global model to generate a global intermediate output;
processing local data comprising the local features using a local model to generate a local intermediate output, wherein the local model comprises a set of local model parameters that have been sampled from a distribution characterized by the determined one or more parameters of the approximated global posterior distribution of local features; and
combining the global intermediate output and local intermediate output to generate a personalized output on the user device.

17. The system of claim 16, wherein determining the one or more parameters of the approximated global posterior distribution of local features by processing the first subset of global features using a shared constructor model further comprises:
determining one or more of mean, variance, or bias parameters of the approximated global posterior distribution of local features.

18. The method of claim 16, further comprising, at each of a number of training iterations:
receiving a ground truth output corresponding with the user input;
determining a loss function based on a discrepancy between the corresponding personalized output and the ground truth output and a divergence between an underlying global posterior distribution of local features and a surrogate posterior distribution, wherein the surrogate posterior distribution has been approximated using variational inference;
updating respective sets of shared parameters comprising respective sets of parameters of the shared embedding model, the shared constructor model, and the shared global model on each user device in accordance with minimizing the loss function; and
transmitting the updated respective sets of shared parameters to the central server with a corresponding number of samples in the user input for the training iteration.

19. The method of claim 16, further comprising, at each training iteration:
receiving globally-updated respective sets of shared parameters that have been aggregated on the central server;
updating the shared embedding model, the shared constructor model, and the shared global model using the globally-updated respective sets of shared parameters; and
sampling the set of local model parameters from the distribution characterized by the determined one or more parameters of the approximated global posterior distribution of local features using the shared constructor model that has been updated with the globally-updated respective sets of shared model parameters.

20. A computer storage medium encoded with a computer program, the program comprising instructions that are operable, when executed by data processing apparatus, to cause the data processing apparatus to perform a method comprising:
receiving a user input from the user device;
processing the user input using a shared embedding model to generate an embedded user input, wherein the embedded user input comprises global and local features;
determining one or more parameters of an approximated global posterior distribution of local features by processing a first subset of global features using a shared constructor model;
processing a second subset of global features using a shared global model to generate a global intermediate output;
processing local data comprising the local features using a local model to generate a local intermediate output, wherein the local model comprises a set of local model parameters that have been sampled from a distribution characterized by the determined one or more parameters of the approximated global posterior distribution of local features; and
combining the global intermediate output and local intermediate output to generate a personalized output on the user device.
